(19) United States
(12) Patent Application Publication
(10) Pub. No.: US 2007/0226694 A1
(43) Pub. Date: Sep. 27, 2007

(54) Control unit for a machine

(76) Inventors: Marc Neufeld, Ludwigsburg (DE); Juergen Hummel, Vaihingen (DE)

Correspondence Address: KENYON & KENYON LLP, ONE BROADWAY, NEW YORK, NY, 10004, US

(21) Appl. No.: 11/643,393

(22) Filed: Dec. 20, 2006

(30) Foreign Application Priority Data
Dec. 20, 2005 (DE) 102005060902.3

(51) Int. Cl. G06F 9/44

(52) U.S. Cl. 717/126

(57) ABSTRACT

A control unit for a machine includes a processor and a memory for program instructions and parameter values. A first portion of the program instructions defines a first process which accesses the parameter values in order to ascertain control information and to transmit same to the machine, and a second portion defines a second process which evaluates the quality of the application data, and either permits or prevents the execution of the first process based on the evaluation results. The second process checks whether the value of at least one first physical parameter specified by the application data is valid and does not permit execution of the first process using these application data unless the value of the parameter has been determined to be valid.

### BACKGROUND OF THE INVENTION

1. Field of the Invention

The present invention relates to a control unit for a machine, e.g., for a prime mover of a motor vehicle.

2. Description of Related Art

Such a control unit generally includes a processor and a memory for application data, i.e., program instructions and parameter values, the program instructions defining at least one first process, in this context also referred to as an application process, which among other functions accesses the parameter values in order to ascertain control information and transmit same to the machine to control the operation thereof.

In particular for control units used in the automotive sector, attempts are often made by unauthorized parties to manipulate application data to, for example, boost the power of a prime mover controlled by the control unit. Such power boosts, not intended by the vehicle manufacturer, may endanger the operational safety of the vehicle, result in a shortened service life of the prime mover or the transmission, or create problems in registering the vehicle. It is therefore important to reliably prevent the operation of such a control unit using application data possibly hazardous to safety.

Integrity test methods are known in which integrity test information is computed from a quantity of data of any given type and compared to reference test information which has been previously computed and stored. When newly computed information and reference test information do not match, this allows a conclusion to be made that the data have been invalidated and that it is not safe to use the data, and an application process which accesses the invalid data is prevented from being executed. In this manner, the likelihood of operation using data that have been manipulated by an unauthorized third party is greatly reduced. However, such an approach does not provide protection in the event that the application process for the control unit operates using application data that have been generated by an authorized party and stored together with matching integrity test information, but which nevertheless specify algorithms or values of operating parameters which do not ensure safe operation of the machine. Such a situation may occur more easily the greater the number of physical parameters which the control unit must detect or adjust in the machine which it controls and which are correlated with one another, so that for these physical parameters it is not possible to specify any given combination of values by use of the application data.

To avoid such problems, methods have been developed for automatically recognizing security-critical parameter values in a set of application data. Security checks based on such methods are usually carried out in a development environment in which the application data have been generated, before the application data are transmitted to a memory for the control unit, so that transmission of nonsecure data to the control unit may be avoided from the outset.

One disadvantage of this approach, however, is that after the application data have been transmitted to the control unit it is no longer possible to verify at the control unit itself whether such a security check has taken place. This makes it difficult for the manufacturer of the control unit to demonstrate that a security check has occurred, if the manufacturer becomes liable for damage allegedly caused by the control unit.

### BRIEF SUMMARY OF THE INVENTION

The present invention provides a control unit which prevents the risk of operation using unsuitable application data, i.e., application data that have been manipulated by an unauthorized party, and application data that have been generated by an authorized party but not checked for security.

This object is achieved according to the present invention by the fact that instead of an integrity test which takes only the binary values of the application data into account, the control unit itself performs as a second process a validity test of the value of at least one first physical parameter represented by the application data, and the application process, referred to below as the first process, may only be executed if the value of the parameter has been determined to be valid.

In contrast to binary data, which by nature are discrete and which can be understood as integers, the physical parameters represented by the application data frequently have real values. For such parameters it is not meaningful to regard a value as valid only if it exactly matches a specified value; it is therefore practical for the validity test to include a step for testing whether the value of the parameter lies within a value interval regarded as valid.

If the application data contain multiple values of physical parameters, such values frequently interact with one another, so that the question of whether a given value of a first parameter is valid, i.e., allows safe operation of the machine, depends on one or more values likewise contained in the application data. In a control unit, such a relationship is often customarily described by a characteristic curve or set of characteristic curves stored in the control unit which specify a desired value of the first parameter as a function of simultaneous values of one or more other parameters. Therefore, it is practical for the second process to include a rule for computing a permissible value or value range for the first parameter, based on at least one second value of a physical parameter represented by the application data, or, in other words, a rule for computing a point on the characteristic curve.

According to a first example embodiment of the present invention, the second process reads the application data from the memory to evaluate the quality of the application data. In other words, the applications to be evaluated are already in the control unit when the method is carried out.

Such a second process may expediently be executed in a preparation phase after the control unit is switched on and before the first process is performed, so that from the outset the first process is prevented from being performed if the evaluation of the quality of the application data has a negative outcome.

It is also possible to carry out the evaluation of the quality of the application data in a post-preparation phase after the first process is performed and before the control unit is switched off. In such a case, the evaluation result must remain stored in the switched-off state of the control unit so that the evaluation result is available when the control unit is switched on once again. This variant may be particularly practical when the first process is capable of altering the operating data, or when spontaneous alterations of the operating data, occurring as the result of a malfunction in the manner of a flash dumper, for example, are to be recognized and intercepted.

If alterations of the operating data which are spontaneous or caused by the first process are to be recognized and intercepted, it is also meaningful to execute the second process in a cyclical manner during operation of the control unit.

According to a second example embodiment, the second process receives the application data from an external source to evaluate the quality of the application data, and does not enter the application data into the memory until the value of each first physical parameter represented by the application data is valid. It is thus possible to prevent any attempt to program the control unit using application data which do not allow safe operation. Since in this embodiment the application data evaluated as unusable do not even enter the memory, the first process is blocked per se from being executed using these application data, without the need for further method steps or precautions for this purpose.

If a set of application data which has been evaluated as usable is already present in the memory at the time that an attempt is made to load the application data from the external source into the memory, the control unit may allow the first process to be executed using these previously stored application data, after the control unit has discarded the new application data from the external source as unusable.

It is also practical for the second process to store along with the application data a test datum computed on the basis of the application data.

This test datum may in particular be computed outside the control unit according to a proprietary method, and be transmitted together with the application data via the interface to the control unit. In this case, the test datum does not necessarily have a function during normal operation of the control unit; however, it may be read from the memory at a later time and be checked for compatibility with the simultaneously stored operating data, so that in the case of incompatibility proof may be established that the operating data have been manipulated by an unauthorized party.

However, the second process may also be set up to recompute the test datum based on the stored application data and to block execution of the first process when incompatibility of the recomputed test datum with the stored test datum indicates that the operating data from which the test datum was computed have been manipulated.

Alternatively, the test datum may also be computed and stored by the control unit itself in the second process, based on application data transmitted to the control unit, when the check of the value of the at least one physical parameter specified by the application data has confirmed the validity of the value. The presence of the test datum thus indicates that a security check has been successfully carried out, and a new security check is necessary only if an integrity test of the application data shows that the application data have been altered. The complicated security check therefore only needs to be performed once in each case, when new application data have been loaded into the control unit, after which a simple integrity test is sufficient to ensure that the application data are operationally secure.

### BRIEF DESCRIPTION OF THE SEVERAL VIEWS OF THE DRAWING

FIG. 1 shows a block diagram of a control unit according to the present invention.

FIG. 2 shows a flowchart of an operating method for the control unit shown in FIG. 1.

FIG. 3 shows a flowchart of an alternative operating method for the control unit shown in FIG. 1.

### DETAILED DESCRIPTION OF THE INVENTION

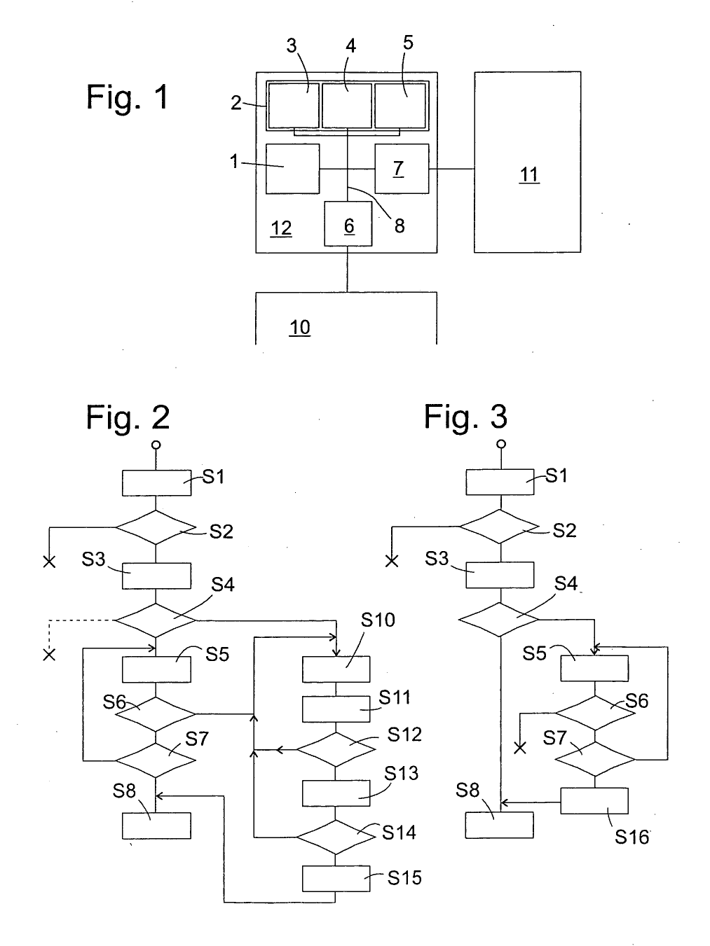

The control unit, denoted in general by reference numeral 12 in FIG. 1, includes a microprocessor 1; a memory 2 which may be composed of a plurality of components such as a volatile random access memory (RAM) 3, a read-only memory (ROM) 4, and an electrically overwritable read-only memory, in particular a flash memory 5; one or more interfaces for communication with sensors and actuators for a machine 10 to be controlled, denoted collectively as machine interface 6; and a programming interface 7 which is connectable to an external data source such as a host computer 11 or a workstation diagnostic device, which are interconnected by a bus 8.

As an application example, the case is considered below in which machine 10 is an engine of a motor vehicle, and control unit 12 is an engine controller. An application program is stored in ROM 4 and/or flash 5 which enables microprocessor 1 to control engine 10, for example by adjusting the ignition angle in engine 10 or the fuel metering and other variables as a function of a determined engine load, gas pedal position, etc. To carry out the control, microprocessor 1 accesses parameter values stored in flash 5 which describe a relationship, to be controlled by the microprocessor, between physical parameters detected for the motor vehicle and parameters to be adjusted for the engine. Proper, safe operation of engine 10 is only possible if the values of these parameters have a meaningful interrelationship. It must therefore be ensured that, for example, an unauthorized party does not load into the memory via machine interface 6 new values for these variables having questionable usability. However, it is also not possible to rule out a priori that parameter values which no longer ensure safe operation have been loaded into the control unit by an authorized party during manufacture of the control unit or its adjustment to the machine to be controlled, or during maintenance activities. To avoid this, the control unit operates in the manner described below with reference to the flow diagram of FIG. 2.

The following description differentiates between a first and a second process, the first process including all operation steps which are directly associated with the control of engine 10, and which would be sufficient for controlling engine 10 if it were not necessary to avert the risk of invalid operating data, whether as the result of faulty entry or technical malfunction in the control unit, whereas a second process includes all tasks used to ensure the usability of the application data and upon which the first process relies.

For the description of the method shown in FIG. 2, it is assumed that the control unit is in a ready-assembled state and programmed at the beginning of the method. Program instructions for executing both processes are stored in ROM 4; a significant portion of the program instructions for the second process contains algorithms which allow a permissible value range to be computed for a first physical parameter represented by the application data, based on values of other parameters contained in the application data.

In a first step S1 of the method shown in FIG. 2, directly after the control unit has been switched on, microprocessor 1 reads from ROM 4 at least a portion of the algorithms which embody the rules for computing the permissible values or value ranges, the instructions which are read being initially processed as binary data words in arithmetic operations to obtain a test datum value, for example, a test sum. In step S2, this test datum value is compared to a datum, likewise read from ROM 4, which represents a test datum value computed at an earlier time. It is possible for this test datum value to have been transmitted, for example together with the algorithms from an external source, to control unit 12, and stored there; however, it is also possible for the control unit to receive only the application data from the external source via interface 7 and to compute the test datum value itself from the received data and to store same.

If the computed test datum value and the stored test datum value do not agree, this means that the algorithms in ROM 4 have been altered, and therefore there is no assurance that the algorithms are still able to perform their function. In this case, microprocessor 1 terminates processing and stops.

If the test datum value computed in step S1 agrees with the stored test datum value, it is assumed that the algorithms have not been manipulated, and the processing continues to step S3, where an integrity test is performed on the parameter values in the same way as in the case of the algorithms in step S1. In step S4 the obtained test datum value is compared to a previously stored test datum value, which, in the same manner as for the test datum value affecting the algorithms, may be externally transmitted to the control unit or may be computed by the microprocessor itself. If the check shows that the parameter values have been altered, the control unit branches into a programming mode whose first step S10 consists in microprocessor 1 waiting for application data to be transmitted to it via machine interface 6. Shifting the microprocessor into standby mode in this manner prevents the microprocessor from controlling engine 10 using the suspected invalid parameter values.

Microprocessor 1 may also be shifted into the standby mode of step S10 at any time by programming interface 7 when programming interface 7 determines that it is connected to a source that is ready to transmit application data.

If the test datum value computed from the parameter values also does not provide an indication of manipulation, the method goes from step S4 to step S5. In step S5 the algorithms checked for integrity in step S1 are used to compute permissible values for at least one other parameter, based on values, contained in the parameter values, of at least one physical parameter measured for the engine. The at least one other parameter is preferably a real value, and the result of the computation in step S5 is a permissible value interval for this parameter. In step S6 a check is performed to determine whether the value of this other parameter specified in the application data lies within the computed interval. If the answer is no, the processor shifts to the standby mode of step S10; otherwise, a check is performed in step S7 to determine whether an additional parameter exists for which a permissible value range may be computed based on the application data. If the answer is yes, the method for this parameter returns to step S5; if not, the validity check for the parameter values is concluded and it is established that the application data may be safely used. Only at this time does the processor begin to perform its actual task of controlling engine 10, as summarized in the diagram as step S8.

Optionally, the execution of step S8 is occasionally interrupted, for example in a controlled manner by use of a timer or when the processor is not working at full capacity, to repeat steps S5 and S6 for individual or all parameter values. In this manner an alteration of the parameter values occurring during operation of the control unit, for example due to manipulation by an unauthorized party or as the result of a technical malfunction in the manner of a flash dumper, for example, may be recognized. In such a situation when engine 10 is running, however, it is practical for the response not to be a transition to standby mode S10, in which execution of engine control S8 is completely prevented, but, rather, transition to a secured mode in which, although the engine continues to run, the operating states for the engine which tend to be endangered by erroneous operating data, in particular at high engine power, are blocked.

In the programming mode, microprocessor 1 continues in the standby mode of S10 until in step S11 data are received from host computer 11 via programming interface 7. These application data are initially stored in RAM 3. To check the authorization of the host computer to program the control unit, step S12 may be provided in which an integrity test value is computed for the new application data and compared to the previously stored integrity test value which has already been used in step S4. If the test values do not match, the microprocessor discards the newly received application data in RAM 3 and returns to step S10.

Since the application data also include data which are not needed by the processor for the engine control in step S8 and therefore may have any given value, an authorized programmer may easily compile the application data to be retransmitted to the control unit 12 in such a way that the application data are accepted in step S12.

When host computer 11 has thus been accepted for authorized programming of the control unit, the microprocessor computes in step S13, in a similar manner as previously performed in step S5, permissible ranges for at least one first parameter based on information contained in the new application data concerning the values of other parameters, and checks whether a value of the first parameter, likewise specified in the application data, lies within the computed interval (S15).

If it is determined for a parameter specified in the new application data that the parameter does not lie within the permissible value range, the new application data are discarded and the microprocessor returns to the standby mode of S10. Step S14 in which flash memory 5 is overwritten with the new application data is only reached when all checked values from the application data lie within the permissible intervals computed for same.

The control operation for the engine (S8) is then resumed, using the altered application data.

An alternative operating method of the control unit is illustrated in FIG. 3. Steps S1 through S3 of this method are the same as in FIG. 2, and are riot described again. The test datum value obtained in step S3 is compared in step S4 to the content of a specified storage location. If agreement is determined, this means that the parameter values have not been manipulated, and the control unit switches directly to the first process (step S8). Disagreement indicates that the parameter values have been altered, the possible reasons for the alteration being that the present values have been manipulated by an authorized or unauthorized party, or that parameter values have been written into flash 5 for the very first time. Regardless of the reason for the disagreement, the control unit performs the described security check with respect to steps S5 through S7 in FIG. 2. If a parameter value does not lie within the permissible range, the method terminates and microprocessor 1 stops. If the result of this test is that the parameter values are secure, step S16 is reached in which the test datum value obtained in step S3 is entered at the memory location queried in step S4, so that upon subsequent repetitions of the operating method in step S4 agreement is determined until the parameter values are altered for any reason. Microprocessor 1 then switches to the first process of step S8.

The methods described above may be used consistently for the totality of all parameter values with which the microprocessor operates. However, the methods may also be used individually for subregions of flash memory 5 containing specific parameter values necessary for certain subtasks of the engine controller, so that if manipulated, impermissible parameter values have been found only in one subregion it is not necessary to block the control unit in its entirety, but, rather, only in the areas in which its functions have been affected by the impermissible parameter values.

1-12. (canceled)

13. A control unit for a machine, comprising:
a processor; and
a memory storing program instructions and parameter values;
wherein the program instructions and the parameter values collectively define application data, and wherein a first portion of the program instructions defines a first process which accesses the parameter values in order to ascertain control information and transmit the control information to the machine, and wherein a second portion of the program instructions defines a second process which evaluates the quality of the application data and selectively permits or prevents the execution of the first process based on the evaluation result, and wherein the second process for evaluating the quality of the application data checks the value of at least one first physical parameter represented by the application data for validity and permits execution of the first process using the application data only if the value of the at least one first physical parameter has been determined to be valid.

14. The control unit as recited in claim 13, wherein the value of the at least one first physical parameter is determined to be valid if the value falls within a permissible value range.

15. The control unit as recited in claim 14, wherein the second process includes a rule for computing the permissible value range for the at least one first physical parameter, based on a value of at least one second physical parameter represented by the application data.

16. The control unit as recited in claim 14, wherein the second process is configured to read the application data from the memory to evaluate the quality of the application data.

17. The control unit as recited in claim 16, wherein the control unit is configured to perform the second process in a preparation phase between switching on of the control unit and execution of the first process.

18. The control unit as recited in claim 16, wherein the control unit is configured to: a) perform the evaluation of the quality of the application data in a post-preparation phase between execution of the first process and switching off; and b) store the evaluation result in the switched-off state of the control unit.

19. The control unit as recited in claim 16, wherein the control unit is configured to execute the second process in a cyclical manner.

20. The control unit as recited in claim 14, further comprising:
an interface for receiving application data from an external source;
wherein the second process receives the application data from the external source via the interface to evaluate the quality of the application data, and wherein the second process enters the application data into the memory only if the value of the at least one first physical parameter represented by the application data is valid.

21. The control unit as recited in claim 20, wherein, if the value of the at least one first physical parameter represented by the application data is invalid, the second process discards the application data received via the interface and permits execution of the first process using application data previously stored in the memory.

22. The control unit as recited in claim 20, wherein the second process stores along with the application data a test datum computed on the basis of the application data.

23. The control unit as recited in claim 22, wherein the second process is configured to: a) recompute the test datum based on the stored application data; and b) prevent execution of the first process if the recomputed test datum is inconsistent with the stored test datum.

24. The control unit as recited in claim 14, wherein the second process checks the integrity of the application data, and wherein the second process evaluates the quality of the application data only if the integrity test indicates that the application data have been altered.
